(19) United States
(12) Patent Application Publication
(10) Pub. No.: US 2010/0047069 A1
(43) Pub. Date: Feb. 25, 2010

(54) Vertical windmill

(76) Inventors: Bright Fong, Fullerton, CA (US); Jemi Fong, Huntington Beach, CA (US)

Correspondence Address: BRIGHT FONG, 2454 CAMBRIDGE AVENUE, FULLERTON, CA, 92835, US

(21) Appl. No.: 12/229,596

(22) Filed: Aug. 25, 2008

(51) Int. Cl. F03D 3/00; F03D 3/06; F03D 11/02; F03D 11/04

(52) U.S. Cl. 416/141; 416/85

(57) ABSTRACT

This invention relates to improving the performance of the conventional vertical windmills. The following strategies are employed to accomplish the objectives:
Modularizing the vane assembly structure to scale up the size and capacity of the windmill without weakening its structural integrity.
Reducing the frictional loss by using buoyancy bearing.
Generating lift to harvest more energy stored in the wind.
Applying the basic mechanical skill and using off-the-shelf parts to reduce initial investment and maintenance cost.

### BACKGROUND

Harnessing wind energy is important to help slow down global warming and ease oil dependency. Currently, the conventional vertical axis windmills are lagging behind the horizontal axis propeller type due to low efficiency.

This invention presents a vertical axis windmill with features that can reduce frictional loss, minimize negative drag, generate lift, increase the windmill size without inducing structural integrity problems, employ no electronic system for operational control, require low initial capital, low-tech manufacturing skill, and low maintenance cost.

### PREVIOUS ARTS

U.S. Pat. No. 4,530,642 by Wei H. Yang disclosed a windmill with wind responsive assembly, plus control processor in response to torque output from the sensor. This arrangement complicates the structure of vertical windmill. And it wastes energy to perform the adjusting function when the size of the windmill is huge and under wind load.

U.S. Pat. No. 4,435,124 by Yea K. Zheng disclosed a windmill with blades which automatically swing outwardly and inwardly when moving on the windward and leeward sides respectively of the axis of rotation. Since the blades are supported at the lower end only, stress induced by heavy wind can overload its structure. The structural integrity under stronger wind condition is worrisome as the blade swings outward and inward without constraint.

Comparing to the previous arts, the merits of this invention revealed are:
1. Simplicity
2. Practicality
3. Higher efficiency
4. Low cost
5. Low maintenance

### SUMMARY

In a preferred embodiment of the invention, a vertical windmill is built by connecting multiple modules of carriages with self pivoting vane assemblies to a central rotating axle. Modularization of the windmill structure makes possible the features of low tech, low cost, and scalability comparing to prior arts.

In addition, a buoyancy bearing is employed to dramatically reduce frictional loss induced by weight, thereby, improving the efficiency of the windmill.

Further more, this invention offers practical ways in achieving the following objectives:
1. Realizing output adjustment and protection by equipping the retractable mobile choking device into the self pivoting vane assembly.
2. Using a unidirectional drive mechanism to generate lift and harness more wind energy.

### DRAWINGS

FIG. 1 shows the vane of the wind response module stopped by the pin (choking device).

FIG. 2 shows the vane of the wind response module swinging outward.

FIG. 3 shows the windmill's basic structure.

FIG. 4 shows the plane view of a vane at different position under wind.

FIG. 5 shows the effect created by several vanes to the air current.

FIG. 6 shows the relation between a vane's effective area and its angle.

FIG. 7 shows a version of a preferred embodiment for large windmill.

FIG. 8 shows a preferred embodiment of the wind responsive module with the choking device mounted on a pivot member.

### WORKING PRINCIPLE

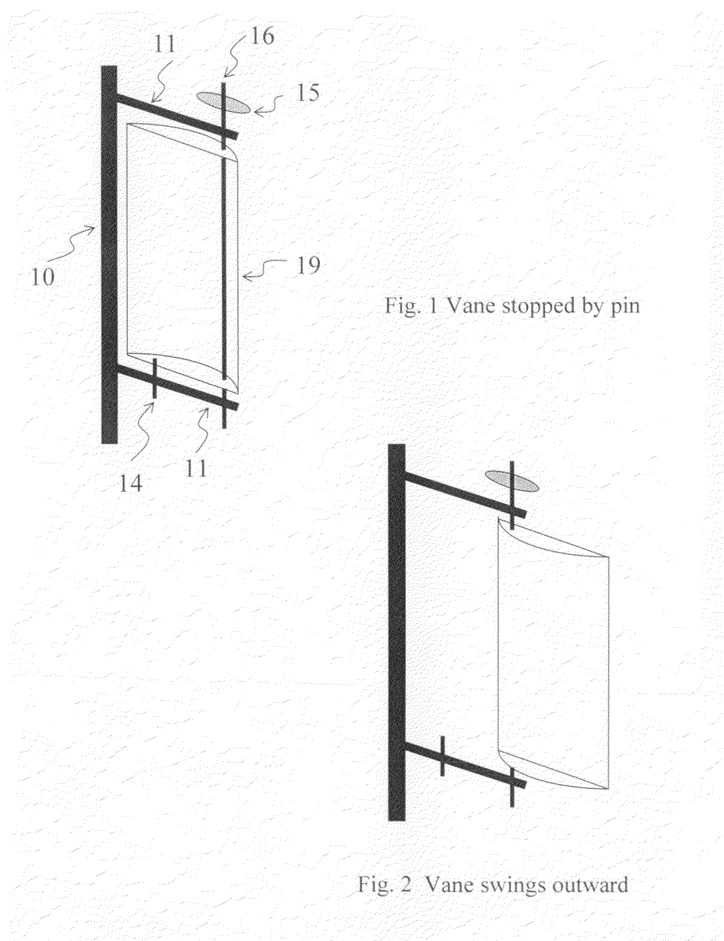

FIG. 1 shows an air-foil shaped vane with pivot shaft journaled to the end of a pair of arms which are fixed to an axle. If wind blows from behind the vane, the vane is stopped by the pin which is mounted on the lower arm. The axle is forced to rotate.

However, if the wind blows from the other direction onto the vane, the vane will swing outward as FIG. 2 indicates.

Applying this arrangement on a vertical windmill with multiple vanes, the vanes traveling downwind, one by one as they receive wind load, will push the windmill to rotate when it is stopped by the pin. Then, as the vane reaches the turning point, it flips over and travels upwind. Now, the vane is free to pivot, it will align itself to point to the wind direction. Therefore the windmill continue to turn as all the vanes traveling down wind receive wind load while all the vanes traveling upwind pose least resistance to wind.

### Basic Structure

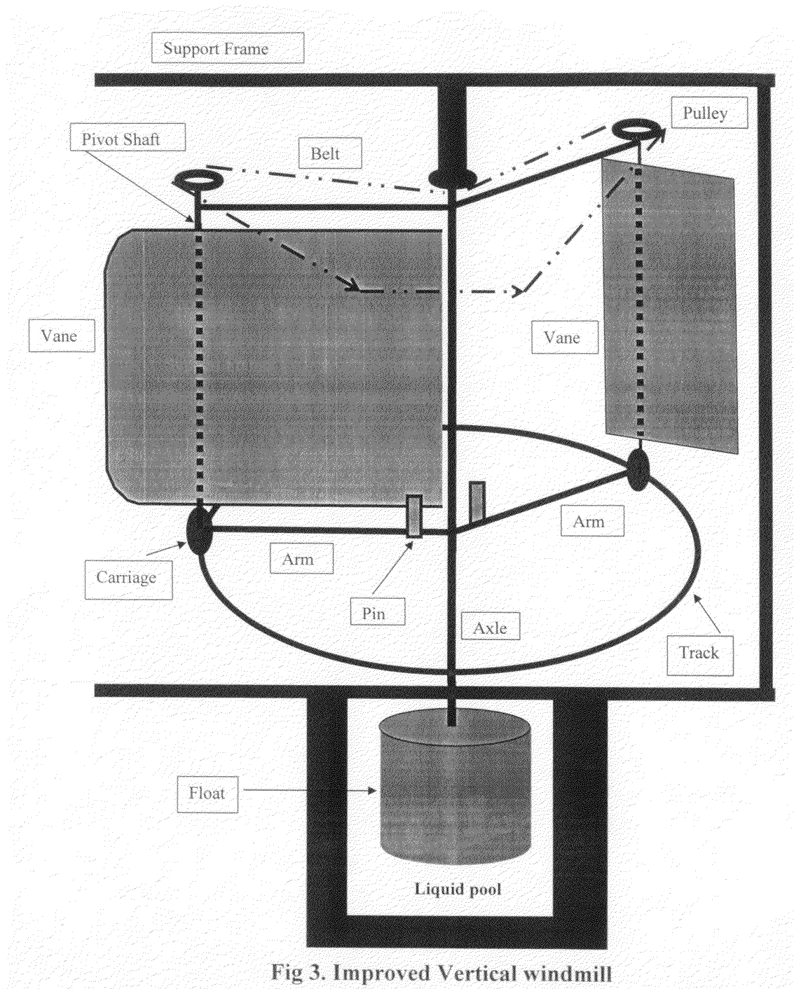

FIG. 3 shows the basic vertical windmill with two vanes for demonstration of its components and structure of this invention.

A liquid pool in the foundation encloses a cylindrical float. Fixed to the float is the center axle. A carriage with wheel is mounted at the ends of a pair of arms. The wheel runs on a circular track. On board the carriage is the wind-responding vane assembly. On top of the vane's pivot shaft has a unidirectional drive pulley. A pair of arms connects the carriage with self pivoting vane assembly to the center axle. A belt connects all unidirectional drive pulleys to the stationary center post for transfer of spin energy of vanes.

### Details of Operation

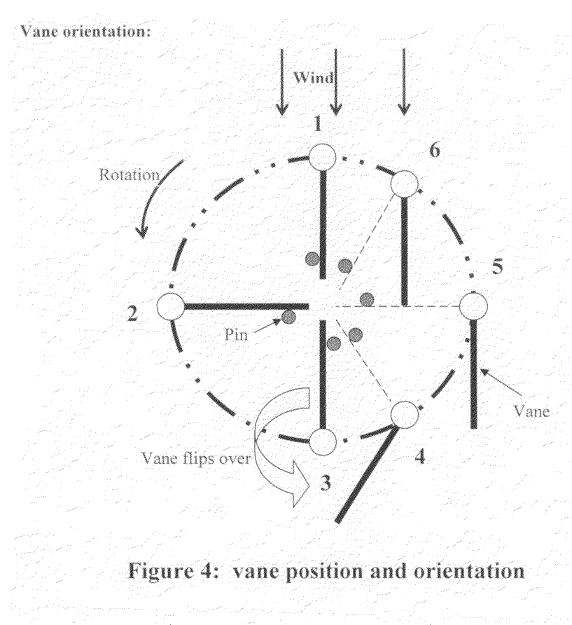

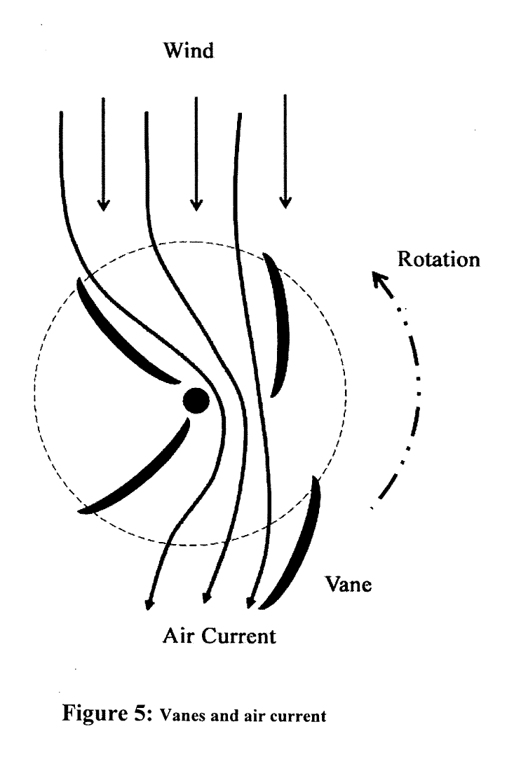

1. Refer to FIG. 4; the wind is pushing the vane from position 1, 2, to 3 because the pin stops the vane from pivoting, forcing the entire windmill rotate counterclockwise as depicted.
2. Once the vane at position 3 moves on further, the vane flips over quickly. The stronger the wind, the faster the vane spins. This self spinning energy of the vane is added to the whole rotating windmill by the pulley which is fitted with unidirectional clutch and is linked to the stationary center post by a belt (not shown).
3. The resistance from the belt keeps the vane angled to wind direction from position 4 through position 5. The vane assumes an angle of attack into the wind generating lift to help rotating the windmill as well.
4. As the vane passes position 5 moving towards position 6, and continues on to position 1, the unidirectional pulley disengages because the wind forces the vane to reverse its rotation (clockwise). The vane starts to line up with the wind direction. Finally it returns to position 1, and the vane is stopped by the pin again.
5. The windmill has completed one full rotation.
6. In practice, there are multiple vanes on a windmill; those vanes within the range from position 5, 6, 1, to position 2 will channel the wind down stream to vanes in the range of position 3, 4, to position 5 which form narrower passage, therefore, directing more power onto the down stream vanes. See FIG. 5.
7. Since the windmill is vertical, the wind pushing on the vane creates tilting moment to the whole rotating assembly. The function of the carriage under each vane is counter balancing the tilting moment to safe guard the integrity of the whole rotating structure.
8. If wind is too strong, all pins can be retracted; then vanes will line up to wind direction. Rotation of the windmill stops. The windmill has minimum resistance to wind.
9. The windmill will start by itself when wind load overcomes the static friction. And it will operate disregarding of wind direction when retractable pins are fully extended.

### Friction Reduction

As the energy density in wind is generally quite low except for hurricanes, the size of the vane has to be pretty big to collect enough energy for economic conversion to electricity. Gravity induces weight. Big size means heavy. The mechanical bearing on the main axle of the conventional windmill has to take all the vertical load of the weight plus the tilting moment. Therefore, frictional loss increases exponentially due to size increase.

This invention uses a cylindrical float in a liquid pool to take the weight off the main bearing. The float is solidly attached to the axle and rotates concentrically with the windmill. Properly adjusting the immersion depth of the float can reduce the vertical load on the main bearing to zero. Since the viscosity of water is quite low, and the windmill usually rotates in low RPM, the frictional loss is reduced greatly by this arrangement; and more useful energy is realized.

### Output Control

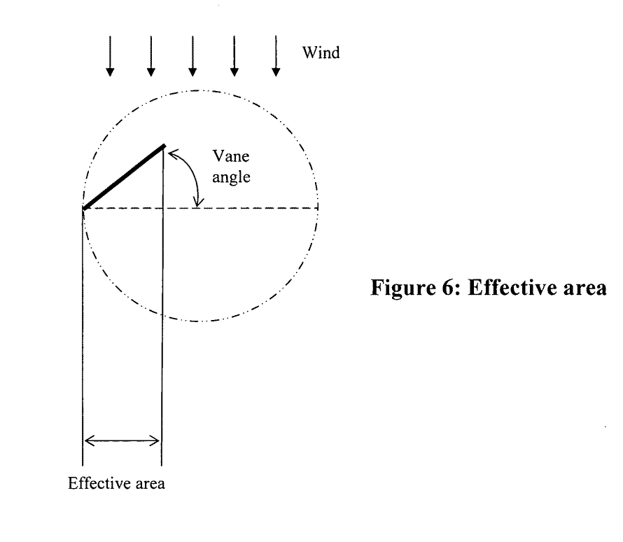

FIG. 6 shows that the effective area a vane receiving wind can be varied by changing the vane angle. Therefore, installing a mobile stopping pin for varying the vane angle can vary the output.

Since there are multiple vanes on a windmill, retracting a stopping pin will disable a corresponding vane from receiving wind. Therefore, the windmill output can be adjusted by disabling partial vanes as well. For example, disabling two vanes will reduce the output of a 4-vane windmill to half.

Thus, installing the retractable stopping pin on a pivotable bar can achieve fine adjustment of the output of a windmill.

### SPECIFICATION

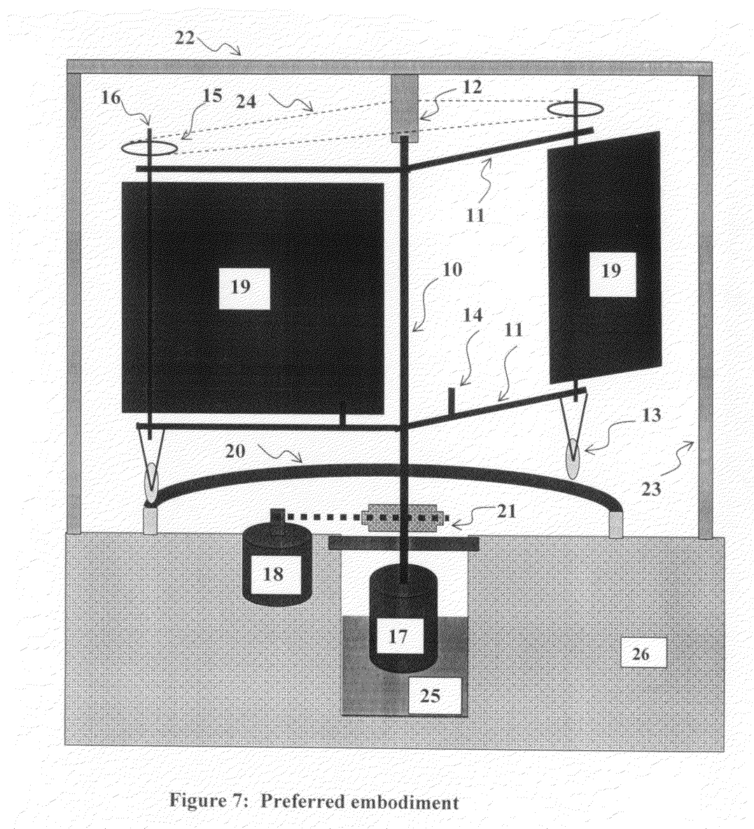

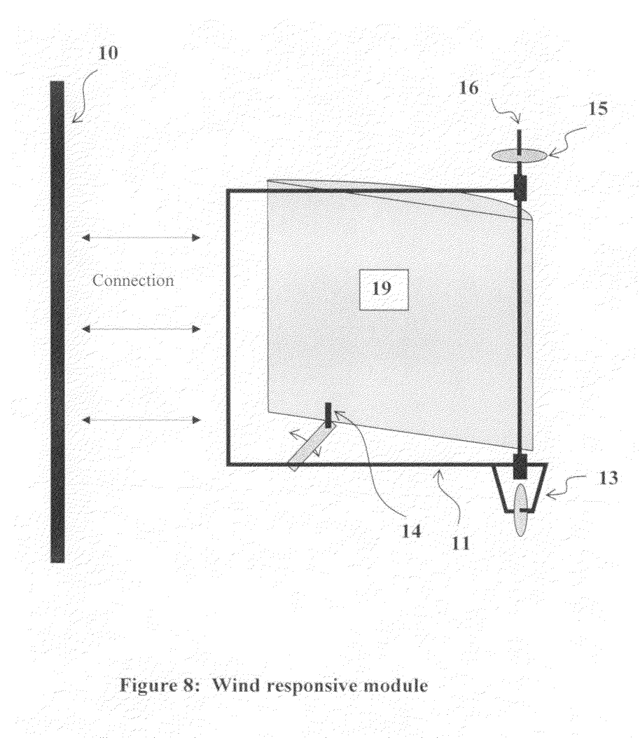

FIG. 7 illustrates a preferred embodiment of this invention. Axle 10 is journaled for rotation vertically by a frame structure 22 supported by columns 23. The post 12 keeps the top end of the axle 10 from tilting while keeping it rotatable. The bottom end of the axle 10 is attached to a float 17 in a liquid pool. A transmission mechanism 21 couples the axle 10 to a generator 18 for power conversion.

Circular track 20, with smooth surface for less friction, either elevated from or flat on the foundation, provides runway for carriage 13. Arms 11 connect carriage 13 to axle 10 forming a solid structure.

Wind responsive vane 19, mounted on top of carriage 13, has a vertically off-centered pivoting shaft 16. Pulley 15 with unidirectional drive clutch is affixed to shaft 16. Belt 24 gangs all pulleys 15 together and wraps around stationary post 12.

Retractable pin 14 is mounted on arm 11 for stopping vane 19 when pin 14 is fully extended. If all pin 14 are retracted, by cable, for example, vanes will be parallel to the wind with least resistance and the rotation of the windmill stops.

For a relatively small vertical windmill, such as a roof top model, the embodiment disclosed above can be scaled down to accommodate the foundation's strength. The track 20, the carriage 13, the float 17 and the liquid pool, can be omitted. And the wind responsive vane assembly can be pivotably mounted directly on a pair of arms affixed to axle 10.

For a medium size windmill, such as a model on top of a public parking structure, the float 17 and water pool can be omitted.

What is claimed is:

1. A windmill comprising a circular run way, a power output axle, supporting means for said power output axle for rotation about a vertical axis, a flotation device mounted to one end of said power output axle, said flotation device immersed in a liquid pool, a generator with power transmission mechanism coupled to said power output axle, multiple wind responsive modules, a belt for ganging said wind responsive modules to a center post on said supporting means, said wind responsive module comprising:
a. wheeled carriage,
b. vane with pivoting shaft journaled for vertical rotation,
c. choking device equipped with disabling means for said vane,
d. unidirectional driving pulley mounted on said pivoting shaft,
e. connecting means to said power output shaft.

2. The structure according to claim 1 wherein said pivot shaft located on said vane off-centered.

3. The structure according to claim 1 wherein said choking device mounted on pivotable means to alter location of said choking device for performing windmill output adjustment.

4. The structure according to claim 1 wherein said vane covered with elastic textile for changing surface contour in response to different wind strength.

5. The structure according to claim 1 wherein said belt made of stretchable elastic material to temporary store the excessive energy from said vane under stronger wind.

6. The structure according to claim 1 wherein said floatation device in cylindrical shape and attached to said power output axle and rotating concentrically.

7. The structure according to claim 1 wherein said liquid pool equipped with liquid depth adjustment means for varying the buoyancy of said floatation device.

8. A windmill comprising, a power output axle, supporting means for said power output axle for rotation about a vertical axis, a generator with power transmission mechanism coupled to said power output axle, multiple pairs of arms affixed to said power output axle, multiple wind responsive vane assemblies each pivotably mounted to a pair of said arms, a belt for ganging said wind responsive vane assemblies to a center post on said supporting means, said wind responsive vane assemblies comprising:
a. vane with pivoting shaft journaled for vertical rotation,
b. choking device equipped with disabling means for said vane.
c. unidirectional driving pulley mounted on said pivot shaft,

9. The structure according to claim 8 wherein said choking device mounted on pivotable means to alter location of said choking device for performing windmill output adjustment.
